(19) United States
(12) Patent Application Publication
(10) Pub. No.: US 2011/0103067 A1
(43) Pub. Date: May 5, 2011

(54) Device for Supporting Light Emitting Module

(75) Inventors: Kazufusa Ago, Tokyo (JP); Katsunari Tsuji, Tokyo (JP)

(73) Assignee: OPTOWORLD CO., LTD., Tokyo (JP)

(21) Appl. No.: 13/001,575

(22) PCT Filed: Jun. 24, 2009
(86) PCT No.: PCT/JP2009/061462

§ 371 Date: Dec. 27, 2010

(30) Foreign Application Priority Data
Jun. 27, 2008 (JP) 2008-004387

(51) Int. Cl. F21S 8/06; F21V 7/00; F21V 7/04

(52) U.S. Cl. 362/296.05; 362/404; 362/296.01

(57) ABSTRACT

Provided is a supporting device that enables light emitting modules to be easily installed on a system ceiling for lighting and is easy to modify the light emitting modules with a simple configuration. For that purpose, the present invention is a supporting device to install an approximately rectangular light emitting module in a plate shape having predetermined dimensions in length and width on a system ceiling in which suspended T bars are arranged in a predetermined dimension at least in parallel on a ceiling The supporting device of the present invention has: a dimension of a long side to be an interval dimension of the T bars in parallel; and an opening having opening dimensions not blocking a light emitting portion of the light emitting module by having a short side dimension smaller than a dimension of a short side of the light emitting module in a direction along the long side of the supporting device. The opening has a recess portion formed on an end side of at least a long side, in accordance with a shape of a peripheral end portion of a long side of the corresponding light emitting module, to board the end portion.

### TECHNICAL FIELD

The present invention relates to a supporting device in a case of installing a light emitting module having a light emitting element, such as a light emitting diode, arranged on a substrate as a lighting device on a ceiling surface, and in particular, relates to a supporting device in a case of installing the light emitting module on a system ceiling.

### BACKGROUND ART

In recent years, for ceilings inside structures, such as buildings, system ceilings are utilized in which suspended T bars in predetermined dimensions of, for example, 600 mm in width or 640 mm in width are arranged on a ceiling in a lattice (grid) pattern and then a standardized ceiling panel or the like is embedded in each of the lattice pattern. In such a system ceiling, a ceiling is formed by dropping a ceiling panel in standardized dimensions of, for example, 600 mm square into each lattice pattern and supporting the ceiling panel with an edge end portion hanging out sideways of the T bar. For such a system ceiling, a fluorescent bulb unit is proposed that is matched to the dimensions of the system ceiling so as to facilitate the installation/removal and relocation (for example, refer to Patent Documents 1 and 2).

In contrast, regarding a lighting device using a light emitting module having a plurality of light emitting diodes arranged on a substrate as well, proposed is one in which a rise in temperature of a light source unit is reduced by, for example, discretely arranging the plurality of light emitting diodes (for example, refer to Patent Document 3). Also proposed is one in which a ceiling of a shelf surface is provided with a light emitting module and each of the plurality of light emitting diodes of the light emitting module is provided with a reflection unit in a curved shape (for example, refer to Patent Document 4).

Regarding heat generation of such a conventional light emitting module using a light emitting diode, since light emitting diodes are generally good in efficiency, the heat generation can be made less in a case of obtaining same illuminance compared to incandescent bulbs. However, compared to fluorescent bulbs in a case of obtaining the same illuminance, light emitting diodes cannot always cut down the amount of heat generation. Also regarding heat generation, since a light emitting diode is generally sealed in a resin package low in thermal conductivity and is implemented on a substrate low in thermal conductivity, there is a disadvantage that heat is prone to accumulate in the periphery of the light emitting element. In a case of a rise in temperature with a light emitting diode, the lifetime of the element is shortened and the light emitting efficiency is decreased. Therefore, it is proposed to install a heatsink plate or a heatsink piece made of metal to improve the heat dissipation property of the light emitting diode on the substrate or at a midpoint of the substrate, make the substrate itself be a conductive thin plate of metal good in thermal conductivity, such as aluminum, or form a through hole, a bump, or a block of copper in the substrate.

The present inventor proposes to use a light emitting module subjected to measures to suppress a rise in temperature not limited to the examples mentioned above in place of a conventional fluorescent bulb. In the light emitting module proposed by the present inventor, in a case of, for example, lighting up by applying a rated voltage of 50 Hz, 100 V in a situation where the ambient temperature is at 27 degrees (power consumption 3.14 {W}, total flux 233 {1 m}), the temperatures both 60 minutes after and 120 minutes after were at 37 degrees (measurement requested to Tokyo Metropolitan Industrial Technology Research Institute: report number 19 requested optical research Nos. 405 through 407). That is, the light emitting module proposed by the present inventor does not rise in temperature higher than 37 degrees in normal use in a case of room temperature at 27 degrees and the electrical power can be cut down greatly.

More specifically, the present light emitting module is in dimensions of approximately 250 mm in length×approximately 18.5 mm in width×1.6 mm (3.5 mm including the light emitting diode) in thickness, and in spite of 3.14 {W} in power consumption, it can irradiate the light intensity equivalent to a fluorescent bulb of 10 {W}. In a case that the light intensity of 40 {W} in terms of a fluorescent bulb is required, four present modules may be used by connecting in series, in parallel, or the like and the power consumption in that case is only 12.56 {W}, and it is possible to greatly contribute to energy saving.

### PRIOR ART DOCUMENTS

Patent Documents
Patent Document 1: Japanese Unexamined Patent Publication No. 2007-103328
Patent Document 2: Japanese Unexamined Patent Publication No. 2007-184182
Patent Document 3: Japanese Unexamined Patent Publication No. 2005-108519
Patent Document 4: Japanese Unexamined Patent Publication No. 2008-4296

However, conventionally, there was no supporting device that can easily install standardized light emitting modules for lighting of light emitting diodes on a ceiling with the number of the light emitting modules being arbitrarily variable. Therefore, conventionally, it had to use an expensive lighting device for exclusive use having outer dimensions formed by matching the dimensions of the grid for a system ceiling, build a supporting device for oneself that is expensive and requires many steps, or process a mounting device for fluorescent bulbs for general use into one for light emitting diodes going through steps. Such conventional devices for supporting light emitting modules are often converted from those for fluorescent bulbs in general, and therefore they used to have a complex and excessively large structure and excessive strength as those for light emitting modules by having an area surrounding the light emitting portion, other than the outgoing plane, covered with a large thick board material or the like in order to allow a stabilizer including a transformer unit, such as an inverter, to be placed thereon and protect fluorescent bulbs damaged easily. Therefore, design modification is also not easy, and the lighting rows of the light emitting modules cannot be easily modified.

### DISCLOSURE OF THE INVENTION

With that, in order to solve the problems mentioned above, it is an object of the present invention to provide a supporting device that can easily install a light emitting module on a system ceiling for lighting and has a simple configuration for easy modification of a number of light emitting modules and replacement thereof.

To solve the problems mentioned above, one embodiment of a device for supporting a light emitting module according to the present invention is a supporting device to install an approximately rectangular light emitting module in a plate shape having predetermined dimensions in length and width on a system ceiling in which suspended T bars are arranged in a predetermined dimension at least in parallel on a ceiling, the supporting device including: a dimension of a long side to be an interval dimension of the T bars in parallel; and an opening having opening dimensions not blocking a light emitting portion of the light emitting module by having a short side dimension smaller than a dimension of a short side of the light emitting module in a direction along the long side of the supporting device, wherein the opening has a recess portion formed on an end side of at least a long side, in accordance with a shape of a peripheral end portion of a long side of the corresponding light emitting module, to board the end portion.

### BRIEF DESCRIPTION OF THE DRAWINGS

FIG. 1 is a top view and a side view illustrating an outline configuration of a light emitting module used for the present invention.

FIG. 2 is a top view and an A-A cross sectional view illustrating an outline configuration in a case that the supporting device of a first embodiment of the present invention is installed on a system ceiling together with light emitting modules.

FIG. 3 is a cross sectional view illustrating by enlarging the periphery of the supporting device on an A-A cross section in FIG. 2.

FIG. 4 is a cross sectional view illustrating by enlarging the periphery of an end portion of the supporting device on a C-C cross section in FIG. 2.

FIG. 5 is a top view and a B-B cross sectional view illustrating an outline configuration in a case that the supporting device of a second embodiment of the present invention is installed on a system ceiling together with light emitting modules.

FIG. 6 is a cross sectional view illustrating by enlarging the periphery of the supporting device on a B-B cross section in FIG. 5.

FIG. 7 is a cross sectional view illustrating by enlarging the periphery of an end portion of the supporting device on a D-D cross section in FIG. 5.

### DETAILED DESCRIPTION OF THE INVENTION

### Overall Description

In order to solve the problems mentioned above, an embodiment of a device for supporting a light emitting module according to claim 1 of the present invention is a supporting device to install an approximately rectangular light emitting module in a plate shape having predetermined dimensions in length and width on a system ceiling in which suspended T bars are arranged in a predetermined dimension at least in parallel on a ceiling, the supporting device including: a dimension of a long side to be an interval dimension of the T bars in parallel; and an opening having opening dimensions not blocking a light emitting portion of the light emitting module by having a short side dimension smaller than a dimension of a short side of the light emitting module in a direction along the long side of the supporting device, wherein the opening has a recess portion formed on an end side of at least a long side, in accordance with a shape of a peripheral end portion of a long side of the corresponding light emitting module, to board the end portion. According to the present invention of claim 1, a light emitting module can be installed easily on a system ceiling for lighting and it has a simple configuration.

In order to solve the problems mentioned above, an embodiment of a device for supporting a light emitting module according to claim 2 of the present invention is a supporting device to install an approximately rectangular light emitting module in a plate shape having predetermined dimensions in length and width on a system ceiling in which suspended T bars are arranged in a predetermined dimension at least in parallel on a ceiling, the supporting device including: a dimension of a long side to be an interval dimension of the T bars in parallel; and two or more of those to be used in which a recess portion is formed at a side edge on a side line on which a peripheral end portion of a long side of at least the light emitting module is boarded in a direction along the long side of the supporting device corresponding to a shape of the peripheral end portion of the long side of the light emitting module, wherein in the recess portion of the long side of one of the supporting devices, the peripheral end portion of the long side on one side of the light emitting module is boarded, and in the recess portion of the long side of another of the supporting devices adjacent to the supporting device, the peripheral end portion of the long side on another side of the light emitting module is boarded. According to the present invention of claim 2, a light emitting module can be installed easily on a system ceiling for lighting and modification of a lighting row can be performed easily with a simple configuration.

Preferably, as the present invention according to claim 3, a short side dimension of the supporting device may also be in a dimension of not more than a half of a value subtracting a short side dimension of the light emitting module from the interval dimension of the T bars in parallel. According to the present invention of claim 3, a light emitting module can be supported by a minimum of two supporting devices for both ends. In addition, modification of a light emitting module is easy as it is done only by adding a light emitting module and an intermediate supporting device.

Preferably, as the present invention according to claim 4, the device may also have a biasing device biasing the light emitting module boarded in the recess portion of the supporting device on a side of the supporting device. In the present embodiment, it is possible to prevent a light emitting module boarded on a recess portion from relocation due to vibration or the like.

Preferably, as the present invention according to claim 5, the recess portion may also be formed in a rail shape possible to be inserted into a surface in a thickness direction of a long side portion of the supporting device by sliding from a side face of the peripheral end portion of the long side of the light emitting module. In the present embodiment, modification of a light emitting module can be performed easily only by inserting or extracting a light emitting module into or from a recess portion in a rail shape.

Preferably, as the present invention according to claim 6, the supporting device may also have a reflective surface portion made of a flat or curved surface projecting on a front side from a light emitting surface of the light emitting module as getting closer to a remote side from the recess portion and reflect light outgoing from the light emitting module. In the present embodiment, light outgoing from a light emitting module can be irradiated effectively to the front side.

Preferably, as the present invention according to claim 7, the supporting device may also have a cross sectional shape of an approximately V shape in a case of supporting the light emitting module in a plurality of rows in parallel and when arranged between the respective light emitting modules. In the present embodiment, modification of a lighting row can be performed easily by adding or taking out a supporting device in an approximately V shape.

### EFFECTS OF THE INVENTION

According to the device for supporting a light emitting module of the present invention, an opening of the supporting device or a slit portion formed by the supporting device are made smaller than a short side dimension of the light emitting module and also a recess portion is provided into which a light emitting module can be fitted, and an end portion of a side of a light emitting module is boarded. This enables a device for supporting a light emitting module to be easily installed with a simple configuration in a case of installing a light emitting module on a system ceiling for lighting. In addition, a supporting device can be easily manufactured that corresponds to the dimensions of the grid on the ceiling by, for example, cutting a supporting device having a length of several fold or more of the light emitting module by matching the dimensions of the system ceiling or the like, and can correspond to an arbitrary number by installing the supporting device in parallel or the like in accordance with the number of light emitting modules to be required.

### DESCRIPTION OF ILLUSTRATED EMBODIMENTS

A detailed description is given below to embodiments of the present invention using the drawings.

<Light Emitting Module>

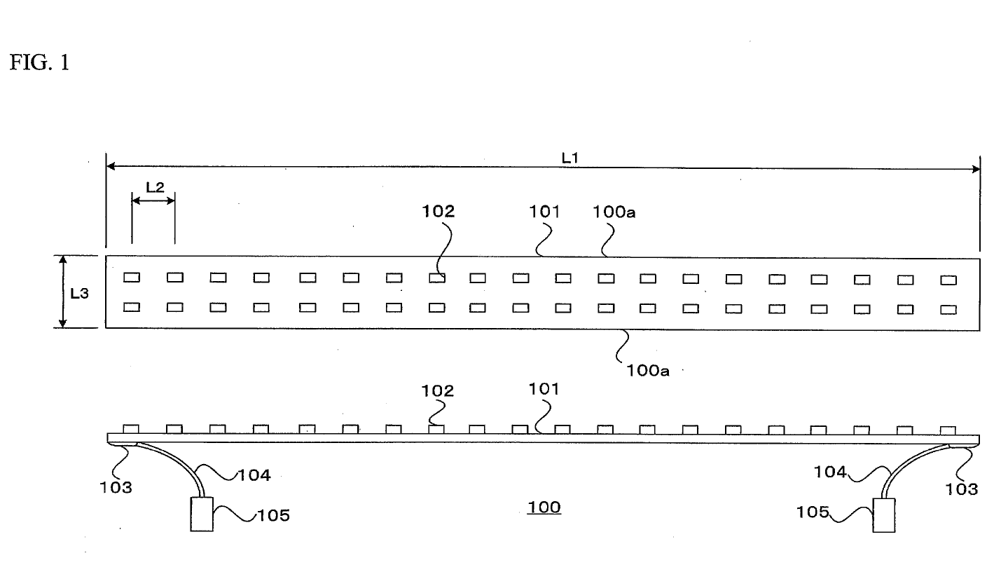

FIG. 1 is a top view and a side view illustrating an outline configuration of a light emitting module used for the present invention.

A light emitting module 100 is in an approximately rectangular plate shape having predetermined length and width dimensions of L1 for the long side and L3 for the short side, in which a plurality of light emitting diodes 102 for lighting are aligned at regular intervals of L2 in series and in two rows on a substrate 101. The intervals between the light emitting diodes 102 are defined by the specification of the light emission intensity and the heat dissipation performance. The arrangement pattern is not limited to the illustrated mode.

Advantages in a case of using the light emitting diodes 102 for lighting include, firstly, that it becomes possible to make the light emitting efficiency better and the power consumption less relative to incandescent bulbs. Although it cannot always apply to fluorescent bulbs because fluorescent bulbs increase in efficiency as the electrical power increases, at least at tens of watts or less, light emitting diodes can be better in efficiency and make the power consumption less. In addition, they may accordingly include that power supply facilities can also be downsized and that the electricity expenses can also be cut down.

Light emitting diodes generally have longer lifetime than incandescent bulbs and fluorescent bulbs, and replacement expenses can be reduced. An advantage normally, which may also be a disadvantage in some cases, may include that light irradiated from a light emitting diode is directional. Although this property is an advantage in a case that the direction of irradiating the light is limited or irradiation is carried out in one direction, it sometimes becomes a disadvantage in a case that the light is intended to be irradiated or is intended to be visually recognized in multi-directions including angles other than the directionality. Disadvantages of light emitting diodes may include that ranges of the voltage and the current in light emission conditions are relatively narrow and they are easily damaged at a voltage or a current in the conditions or more and that those of high brightness for lighting are higher in price.

On the substrate 101, wiring to supply a voltage/current for light emission to each light emitting diode 102 is formed by printing of a conductor pattern, etching after exposure, or the like. The wiring is connected to one end of a lead wire 104 with a connection unit 103 formed on a non-emission surface, and a connector 105 to be connected to an external power supply or the like is mounted at the other end portion of the lead wire 104.

### FIRST EMBODIMENT

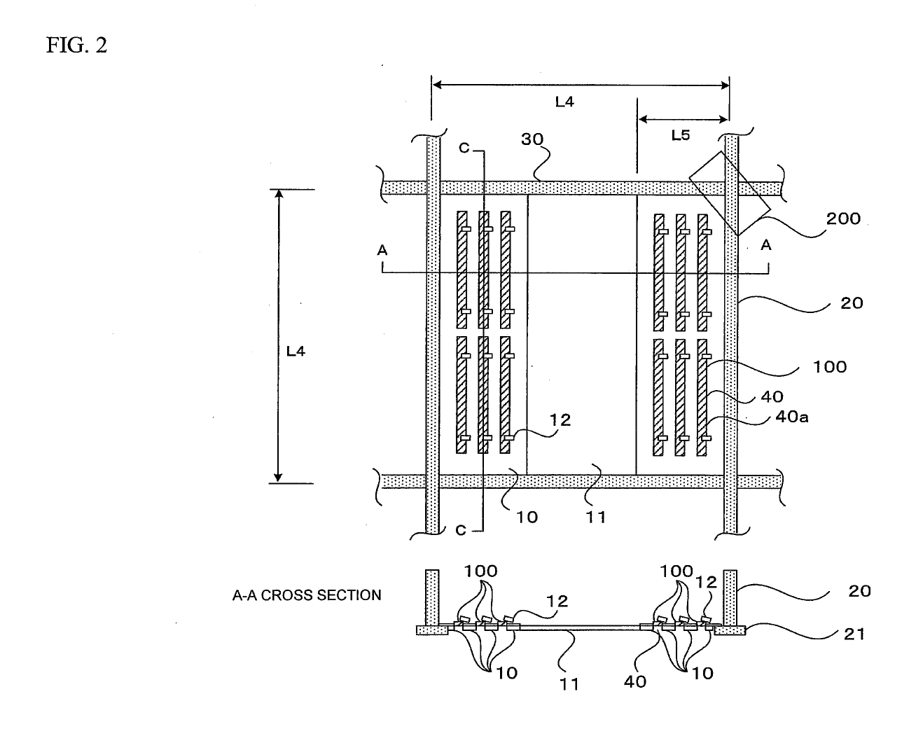

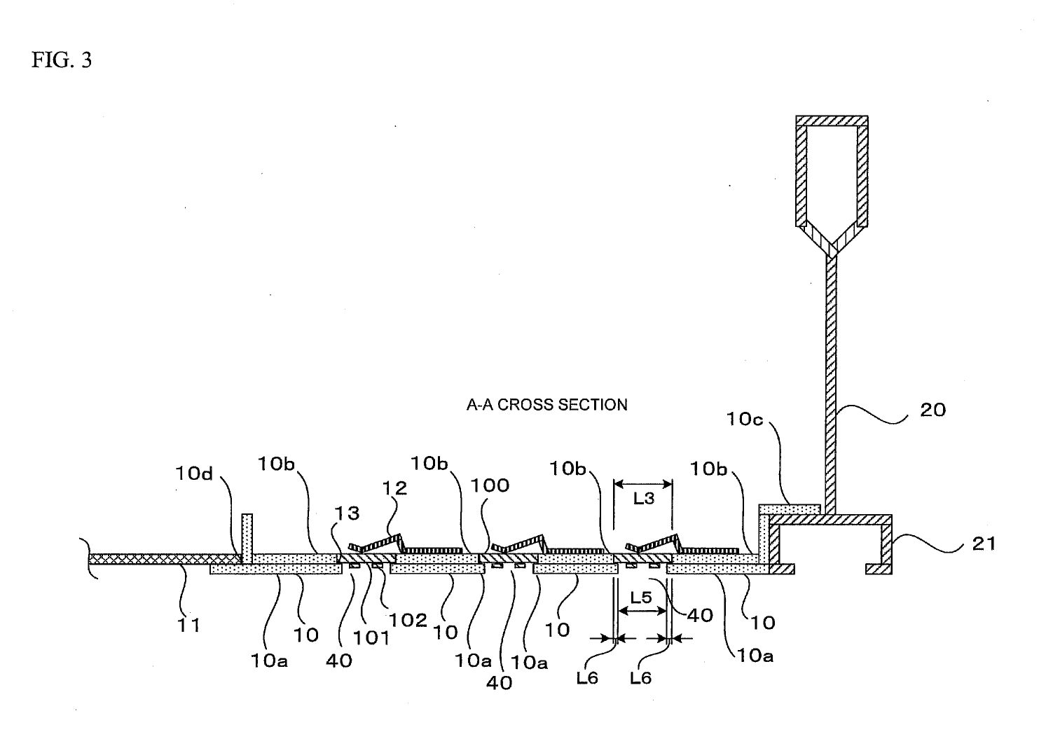

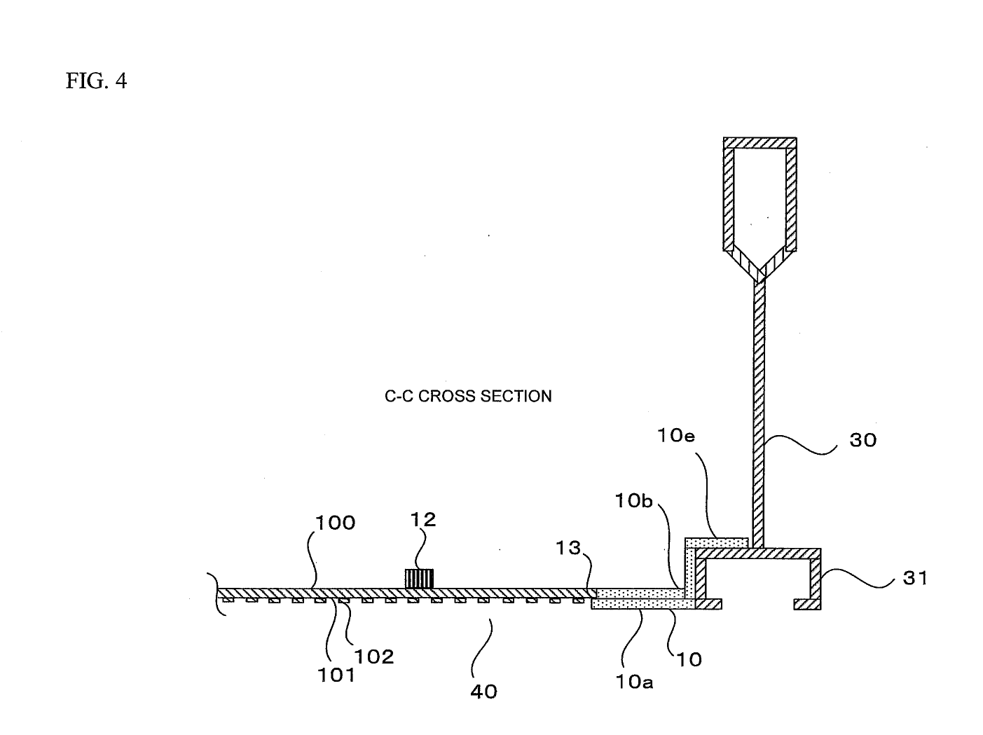

FIG. 2 is a top view and an A-A cross sectional view illustrating an outline configuration in a case that a supporting device of the first embodiment of the present invention is installed on a system ceiling together with light emitting modules. FIG. 3 is a cross sectional view illustrating by enlarging the periphery of the supporting device on the A-A cross section in FIG. 2. FIG. 4 is a cross sectional view illustrating by enlarging the periphery of an end portion of the supporting device on a C-C cross section in FIG. 2.

A supporting device 10 is a device for installing a light emitting module 100 on a system ceiling and has a dimension of a long side of, for example, a grid interval (interval dimension L4 of T bars 30 in parallel described later) of the system ceiling and a short side dimension of, for example, a half or less dimension of a value subtracting the short side dimension of the light emitting modules 100 from the grid interval dimension L4 of the system ceiling, and further has an opening 40. The supporting device 10 may be fabricated by molding, for example, a cold-rolled sheet steel (SPC material). Further, the supporting device 10 may also be formed by adhesion, welding, or the like by laminating two sheets of SPC materials (10a, 10b). Edge ends in areas surrounding the supporting device 10 may also be formed with a stair portion 10c to be dropped into an edge end portion 21 hanging out sideways of the T bar 20 described later for fixation, a stair portion 10e to be dropped into an edge end portion 31 hanging out sideways of the T bar 30 described later for fixation, and an overhang 10d to support an adjusting plate 11 described later. Processing of the SPC materials may employ a pressing apparatus or the like used for general machining process. In the present embodiment, the short side dimension of the supporting device 10 mentioned above is one example, and it can be an arbitrary value of not more than the grid interval L4 and not less than the short side dimension of the light emitting modules 100 in accordance with the number required by the light emitting modules 100.

The opening 40 is provided by machining process at an arbitrary position of the supporting device 10. In addition, as described later, in a part of the supporting component 10 at least facing an end side 40a of the long side, a recess portion 13 having a cross sectional shape approximately equal to a cross sectional shape of a peripheral end portion 100a of the long side of the corresponding light emitting modules 100 is formed to board the end portion 100a. A recess portion may also be formed similarly on an end side of a short side of the opening 40.

The adjusting plate 11 is a plate that fills a part in the grid not covered with the supporting device 10, and for example, in a case that a width dimension of the supporting device varies with the number of light emitting modules to be used, such as each case of one row, two rows, or three rows of the light emitting modules, a width dimension of this plate is differentiated for one row, two rows, and three rows, thereby adjusting to fill the part in the grid not covered with the supporting device 10. This plate may also be a plate for facilities, such as a ventilation fan or a speaker.

A biasing device 12 is formed with a material having a spring property so as to enable the light emitting modules 100 boarded in the recess portion 13 of the supporting device 10 to be biased on the supporting device 10 side (may also be referred to as the light emitting diode 102 side of the substrate 101 or the light irradiation direction side), for example, an elastic material or a metal material having a spring property. The biasing device 12 may be fixed, for example, on the supporting device 10 by adhesion or welding.

The recess portion 13 has a cross sectional shape approximately equal to the cross sectional shape of the peripheral end portion 100a of the long side of the corresponding light emitting modules 100 as described before in the part of the supporting component 10 facing at least the end side 40a of the long side of the opening 40 and is formed to board the end portion 100a. The recess portion 13 may also be foamed by differentiating the width dimensions of the top and bottom openings in, for example, the two sheets of SPC materials (10a, 10b) of the supporting device 10 mentioned above. In that case, the opening width dimension of the SPC material 10a is set as L5 (L3>L5: L3=L5+2×L6), and the opening width dimension of the SPC material 10b is set as L3. By overlapping the SPC material 10a and the SPC material 10b, a stair by L6 is formed at both ends of the opening in the width direction. This stair by L6 can be set as the recess portion 13. The recess portion 13 may also be formed by, other than the method of overlapping two sheets of metal boards mentioned above, a method of grounding one of the surfaces of one sheet of a board by machining process or a chemical method, such as etching.

The T bars 20 are suspended from a roof, an upstairs floor, or the like, and are installed vertically and horizontally in parallel in predetermined dimensions, such as 600 mm or 640 mm, and are frame components parallel to the long side of the light emitting modules 100 and/or the long side of the opening 40 out of a frame to form a ceiling by dropping the ceiling plates in standardized dimensions, such as 600 mm×600 mm.

An edge end portion 21 is a part at an edge end hanging out sideways of the T bar 20.

The T bars 30 are frame components parallel to the short side of the light emitting modules 100 and/or the short side of the opening 40 out of a frame to form the ceiling.

The system ceiling is in predetermined dimensions, such as 600 mm or 640 mm, as mentioned above, and a grid is formed in which the T bars 20 and 30 in parallel are arranged vertically and horizontally in a lattice pattern. Accordingly, the intervals between the T bars in parallel are also in a predetermined dimension, such as 600 mm or 640 mm. The system ceiling may also be installed in a predetermined dimension, such as 300 mm, 900 mm, or 1800 mm.

The opening 40 is in opening dimensions not blocking the light emitting portion 102 of the light emitting modules 100 by having a short side dimension smaller than the dimension L3 of the short side of the light emitting modules 100 in a direction along the long side of the supporting device.

In the opening 40, the recess portion 13 mentioned above is formed at least at the end side of the long side.

A power supply unit 200 is connected directly or indirectly to the connector 105 of each light emitting module 100 on one side and connected to a commercial power supply (100 V, 200 V, or the like) on the other side to supply a rated voltage/rated current (for example, 24 V/130 mA, or the like) of each light emitting module 100 by transforming the voltage using an inverter or the like.

In a case of using the supporting device 10 of the present embodiment installed on a system ceiling, when replacing the light emitting module 100, the adjusting plate 11, for example, is removed to remove the light emitting module 100 to be replaced from the back side of the supporting device through the opening 40 and also to remove the connector 105 from the connection with the power supply unit 200. Then, after a new light emitting module 100 is connected to the connector 105, it may be installed in the opening 40. In a case that the illuminance is intended to be reduced, a blindfold plate for filling the space or the like may also be installed in place of the light emitting module 100. The replacement of the light emitting modules 100 may also be performed by removing the adjusting plate 11 and also removing the supporting device 10.

In such a manner, in the supporting device 10 of the present embodiment, the light emitting modules 100 can be installed easily for lighting in the T bars 20 and 30 on a system ceiling, and the replacement of the light emitting module 100 can be performed easily with a simple configuration, and the light emitting modules 100 boarded on the recess portion 13 can be prevented from relocation by vibration or the like.

### SECOND EMBODIMENT

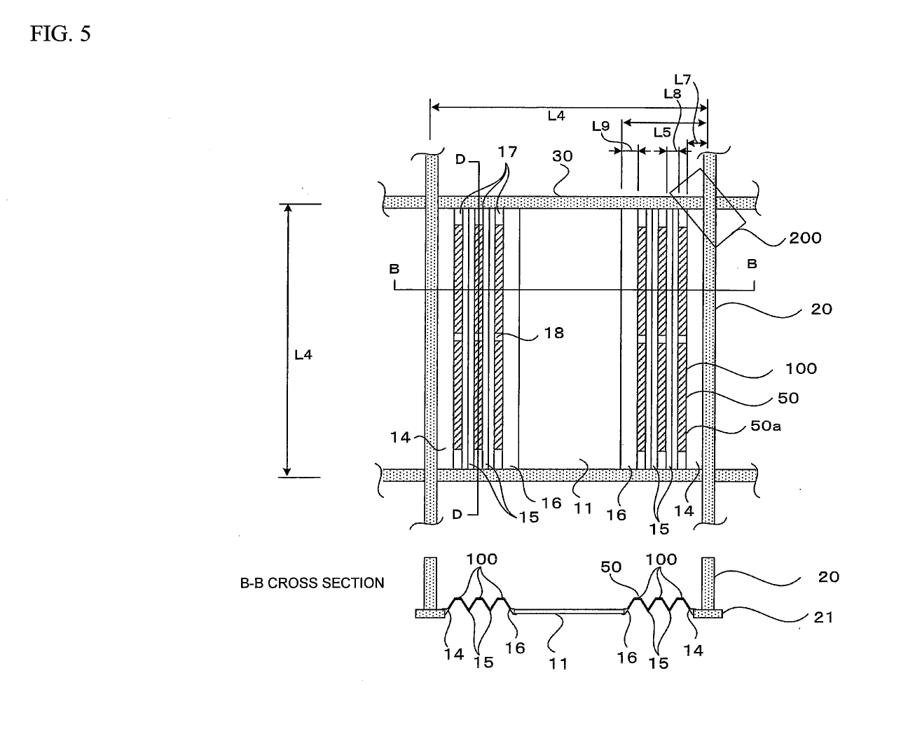

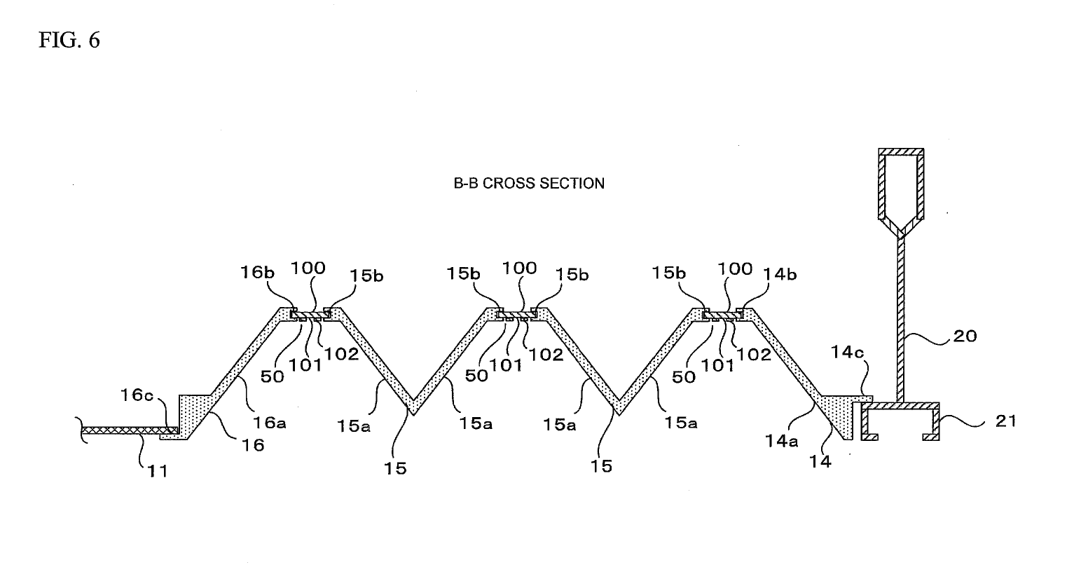

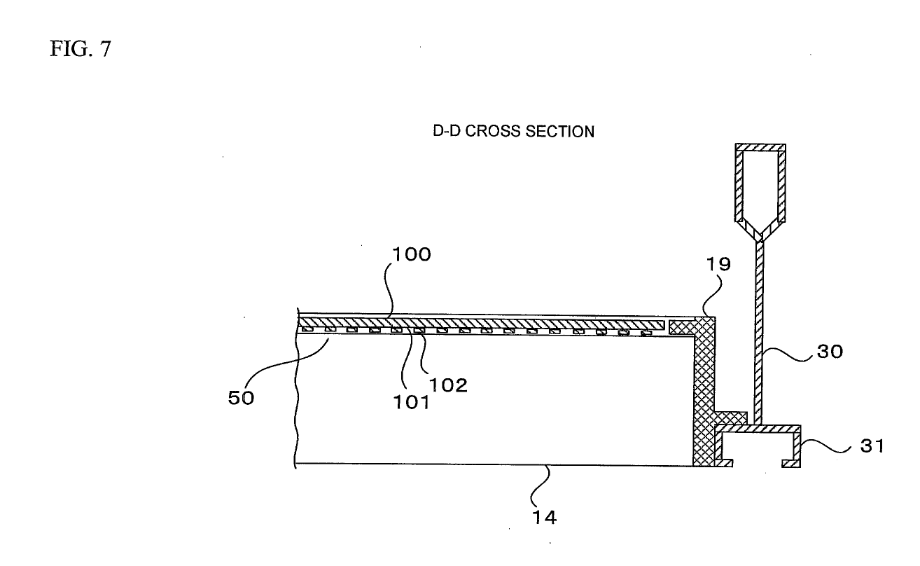

FIG. 5 is a top view and a B-B cross sectional view illustrating an outline configuration in a case that a supporting device of the second embodiment of the present invention is installed on a system ceiling together with the light emitting modules. FIG. 6 is a cross sectional view illustrating by enlarging the periphery of the supporting device on a B-B cross section in FIG. 5. FIG. 7 is a cross sectional view illustrating by enlarging the periphery of an end portion of the supporting device on a D-D cross section in FIG. 5.

Supporting devices 14, 15, and 16 are devices to install light emitting modules 100 on a system ceiling respectively, and have a dimension of a long side as, for example, the grid intervals (interval dimension L4 of the parallel T bars 30 described later) of the system ceiling.

The supporting devices 14, 15, and 16 have reflective surface portions 14a, 15a, and 16a that are made of flat or curved surfaces projecting on a front side from the light emitting surfaces of the light emitting modules 100 as getting closer to a remote side from the recess portions 14b, 15b, and 16b and that reflect light outgoing from the light emitting modules 100. For example, in a case that the irradiation angle of the light emitting diodes 102 of the light emitting modules 100 is 110 degrees, the reflective surface portions 14a, 15a, and 16a are formed at an angle that can reflect the left and right (reflective surfaces on both sides) end portions of the outgoing light spanning at 110 degrees forward.

The supporting devices 14 and 16 are used for all cases of supporting the light emitting modules 100 in one or more rows. In contrast, the supporting device 15 is used only for a case of supporting the light emitting modules 100 in a plurality of rows in parallel. The cross sectional shape of the supporting device 15 becomes in an approximately V shape in a case of arranged between the respective light emitting modules 100 in two or more rows.

The supporting devices 14, 15, and 16 has a short side dimension differentiated for the setting of the irradiation angle having directionality of the light emitting diodes 102 on the light emitting modules 100, the number of rows of the light emitting modules 100, and the angles and the width dimensions of the reflective surface portions 14a, 15a, and 16a.

The recess portions 14b, 15b, and 16b are formed at a side edge on the side line, at least on which the peripheral end portion 100a of the long side of the light emitting modules 100 are boarded, in a direction along the long sides of the supporting devices 14, 15, and 16 in a groove shape continuing from one end to the other end of the side face in the long side corresponding to the shape (thickness dimension) of the peripheral end portion 100a of the long side of the light emitting modules 100.

More specifically, the recess portions 14b, 15b, and 16b are foamed in a rail shape possible to insert the peripheral end portion 100a of the long side of the light emitting modules 100 by sliding from the side face into a surface in a thickness direction of the long side of the supporting devices 14, 15, and 16.

When using the supporting devices 14, 15, and 16, a pair of the recess portions 14b and 15b and a pair of the recess portions 15b and 16b are arranged to face across the respective light emitting modules 100.

In a case of using the light emitting modules 100 in one row, the two supporting devices of 14 and 16 are used and groove portions 50 are formed in one row to insert the light emitting modules 100 between the recess portions 14b and 16b. Consequently, at end portions 50a of the long side of the groove portions 50, the recess portions 14b and 16b are arranged. The light emitting modules 100 are inserted between these recess portions 14b and 16b and the groove portions 50 are fixed by closing with spacers 17 and 18, an end plate 19, and the like described later to use the light emitting modules 100 as a light source for the lighting device.

In a case of using two rows of the light emitting modules 100, the three supporting devices of 14, 15, and 16 are used and two rows of the groove portions 50 are formed to insert the respective light emitting modules 100 between the recess portions 14b and 15b and between the recess portions 15b and 16b. Consequently, at end portions 50a of the long side of the groove portions 50, the recess portions 14b and 15b are arranged in the first row and the recess portions 15b and 16b are arranged in the second row. The respective light emitting modules 100 are inserted between the recess portions 14b and 15b and between the recess portions 15b and 16b, and the respective groove portions 50 are fixed by closing with the spacers 17 and 18, the end plate 19, and the like described later to use the respective light emitting modules 100 as a light source for the lighting device.

In a case of using three rows of the light emitting modules 100, four supporting devices of 14, two of 15, and 16 are used to form three rows of the groove portions 50 to insert the respective light emitting modules 100 between the recess portions 14b and 15b, between the recess portion 15b and the facing and adjacent recess portion 15b, and between the recess portions 15b and 16b. Consequently, at the end portions 50a of the long side of the groove portions 50, the recess portions 14b and 15b are arranged in the first row, the recess portion 15b and the facing and adjacent recess portion 15b are arranged in the second row, and the recess portions 15b and 16b are arranged in the third row. The respective light emitting modules 100 are inserted between these recess portions 14b and 15b, between the recess portion 15b and the facing and adjacent recess portion 15b, and between the recess portions 15b and 16b, and the respective groove portions 50 are fixed by closing with the spacers 17 and 18, the end plate 19, and the like described later to use the respective light emitting modules 100 as a light source for a lighting device.

In a case of using four or more rows of the light emitting modules 100, the groove portions 50 are added by adding the number of row(s) of the supporting device(s) 15 relative to the case of three rows mentioned above, and the required number of the supporting device(s) 15 in addition to the two supporting devices of 14 and 16 are used to form the groove portions 50 in the required number of rows to insert the respective light emitting modules 100 between the recess portions 14b and 15b, between the recess portion 15b and the facing and adjacent recess portion 15b, and between the recess portions 15b and 16b. Consequently, at the end portions 50a of the long side of the groove portions 50, the recess portions 14b and 15b are arranged in the first row, the recess portion 15b and the facing and adjacent recess portion 15b are arranged in the second row or later other than the last row, and the recess portions 15b and 16b are arranged in the last row. The respective light emitting modules 100 are inserted between the recess portions 14b and 15b, between the recess portion 15b and the facing and adjacent recess portion 15b, and between the recess portions 15b and 16b, and the respective groove portions 50 are fixed by closing with the spacers 17 and 18, the end plate 19, and the like described later to use the respective light emitting modules 100 as a light source for the lighting device.

That is, in the recess portions 14b, 15b, and 16b of the long side of each one of the supporting devices 14, 15, and 16, the peripheral end portion 100a of the long side on one side of the light emitting modules 100 is boarded. On the other hand, in the recess portions 14b, 15b, and 16b of the long side of other adjacent supporting devices 14, 15, and 16 facing the supporting devices 14, 15, and 16 across the light emitting modules 100, the peripheral end portion 100a of the long side on the other side of the light emitting modules 100 is boarded.

In the present embodiment, in a case that the required illuminance is high, it is possible to add the supporting device(s) 15 to make the rows of the light emitting modules 100 more than the illustrated three rows to four or more rows. On the contrary, as the minimum configuration, it is possible to make the rows of the light emitting modules 100 into one row by eliminating the supporting device(s) 15. That is, by adding or deleting the supporting device 15, the light emitting modules 100 can be in an arbitrary number of row(s) in a range of one or more rows possible to install in the grid interval dimension L4 of the system ceiling.

The supporting devices 14, 15, and 16 can be fabricated by extrusion molding of, for example, aluminum In each of the supporting devices 14, 15, and 16, the reflective surface portions 14a, 15a, and 16a may be formed respectively that project from the side face of the light emitting modules 100 in a diagonally forward direction.

The extrusion process of an aluminum material may also be hot processing that extrudes at a high pressure using a pressing apparatus, molds (dies), and the like used for general machining process.

At an edge end on the T bar 20 side of the supporting device 14, a stair portion 14c is provided to be dropped into and fixed on the edge end portion 21 hanging out sideways of the T bar 20. At an edge end on the adjusting plate 11 side of the supporting device 16, a projection portion 16c is provided to drop the adjusting plate 11 for fixation.

The spacers 17 and 18 are formed in a plate shape having a thickness dimension equivalent to that of the light emitting modules in order to fill a space for fixing the light emitting modules 100 on the recess portions 14b, 15b, and 16b in a rail shape.

The end plate 19 is a plate that closes an edge end on the T bar 30 side of the extrusion molded supporting devices 14, 15, and 16. The edge end on the T bar 30 side of the end plate 19 has a stair portion 19a to be dropped into and fixed on the edge end portion 31 hanging out sideways of the T bar 30 and a protrusion 19b to fix the light emitting modules 100 inserted into the recess portions 14b, 15b, and 16b in a rail shape in cooperation with the spacers 17 and 18.

In the present embodiment, the dimensions of the short side of the supporting devices 14, 15, and 16 mentioned above are one example and can be an arbitrary value of not more than a half of a value subtracting the short side dimension of the light emitting modules 100 from the grid intervals L4 in accordance with the light emission intensity of the light emitting modules 100, the required light intensity, the angles, the curvature, and the areas of the reflection boards, the number of rows of the supporting devices possible to be installed in the grid intervals L4, or the like.

The groove portions 50 are grooves (spaces) formed, by facingly arranging any two of the supporting devices 14, 15, and 16 in the width of the light emitting modules 100, therebetween to install the light emitting modules 100.

In the part of the supporting devices 14, 15, and 16 corresponding to at least an end side 50a of the long side, the recess portions 14b, 15b, and 16b are formed to board the end portions 100a.

The adjusting plate 11 is a plate that fills a part not covered with the supporting devices 14, 15, and 16 in the grid, and for example, in a case that a width dimension of the supporting device varies with the number of light emitting modules to be used, such as each case of one row, two rows, or three rows of the light emitting modules, a width dimension of this plate is differentiated for one row, two rows, three rows, . . . , thereby adjusting to fill the part in the grid not covered with the supporting devices 10. This plate may also be a plate for facilities, such as a ventilation fan or a speaker.

In the part of the supporting devices 14, 15, and 16 facing at least the end side 50a of the long side of the groove portions 50, the recess portions 14b, 15b, and 16b are formed in accordance with the shape (thickness dimension) of the peripheral end portions 100a of the long side of the corresponding light emitting modules 100 in order to board the end portions 100a by insertion.

The groove portions 50 have a groove width dimension smaller than the dimension L3 of the short side of the light emitting modules 100 in the direction along the long side of the supporting device but have a groove width dimension larger than the dimension L3 of the short side of the light emitting modules 100 as the dimension of any two of the facing recess portions 14b, 15b, and 16b to the backmost portions, and have the opening dimensions not blocking the light emitting portion 102 of the light emitting modules 100.

Since the power supply unit 200, the system ceiling, the T bars 20, and the T bars 30 are similar to those of the first embodiment, descriptions thereof are omitted.

In a case of using the supporting devices 14, 15, and 16 of the present embodiment installed on a system ceiling, when replacing the light emitting module 100, the adjusting plate 11, for example, is removed to remove the connector 105. After that, replacement of the light emitting module 100 is performed by removing the supporting devices 14, 15, and 16 and removing the end plate 19. After that, a new light emitting module 100 is inserted into the supporting devices 14, 15, and 16 and the end plate 19 is mounted, and then the connector may be connected.

In a case that the illuminance is intended to be reduced by reducing the number of rows of the light emitting modules 100 in one row, one row of the supporting device 15 and the light emitting modules 100 may also be deleted to reassembly the rest of the supporting devices 14, 15, and 16.

In such a manner, in the supporting device 14, 15, and 16 of the present embodiment, the light emitting modules 100 can be installed easily for lighting in the T bars 20 and 30 on a system ceiling, and the replacement of the light emitting module 100 can be performed easily with a simple configuration, and the light emitting modules 100 can be supported by a minimum of the two supporting devices 14 and 16 at both ends. In addition, modification of the lighting row can be carried out easily only by adding or taking out the light emitting modules 100 and the intermediate supporting device 15 in an approximately V shape.

In the present embodiment, modification of the light emitting module 100 can be performed easily only by inserting or extracting the light emitting module 100 into or from the recess portions 14b, 15b, and 16b in a rail shape, and the light outgoing from the light emitting modules 100 can be irradiated effectively to the front side by reflecting on the reflective surface portions 14a, 15a, and 16a.

Although the device for supporting a light emitting module according to the present invention has been described above using the embodiments, the technical scope of the present invention is not limited to the range of the supporting devices described in the embodiments mentioned above. It is also applicable to a device having a configuration other than the above as long as it is a supporting unit in a plate shape having an opening for the light emitting modules 100 or a supporting unit in a plate shape supporting by sandwiching the side faces of the light emitting modules 100. In addition, the device for supporting a light emitting module according to the present invention may also be provided with a mounting hole, a groove, or the like on the reflective surface portions to mount a louver and may also be provided with a mounting hole, a groove, or the like on the reflective surface portions or an outer periphery to mount an acrylic cover.

1. A device for supporting a light emitting module to install an approximately rectangular light emitting module in a plate shape having predetermined dimensions in length and width on a system ceiling in which suspended T bars are arranged in a predetermined dimension at least in parallel on a ceiling, the supporting device comprising:
a dimension of a long side to be an interval dimension of the T bars in parallel; and
an opening having opening dimensions not blocking a light emitting portion of the light emitting module by having a short side dimension smaller than a dimension of a short side of the light emitting module in a direction along the long side of the supporting device, wherein
the opening has a recess portion formed on an end side of at least a long side, in accordance with a shape of a peripheral end portion of a long side of the corresponding light emitting module, to board the end portion.

2. A device for supporting a light emitting module to install an approximately rectangular light emitting module in a plate shape having predetermined dimensions in length and width on a system ceiling in which suspended T bars are arranged in a predetermined dimension at least in parallel on a ceiling, the supporting device comprising:
a dimension of a long side to be an interval dimension of the T bars in parallel; and
two or more of those to be used in which a recess portion is formed at a side edge on a side line on which a peripheral end portion of a long side of at least the light emitting module is boarded in a direction along the long side of the supporting device corresponding to a shape of the peripheral end portion of the long side of the light emitting module, wherein
in the recess portion of the long side of one of the supporting devices, the peripheral end portion of the long side on one side of the light emitting module is boarded, and
in the recess portion of the long side of another of the supporting devices adjacent to the supporting device, the peripheral end portion of the long side on another side of the light emitting module is boarded.

3. The device for supporting a light emitting module according to claim 2, wherein
a short side dimension of the supporting device is in a dimension of not more than a half of a value subtracting a short side dimension of the light emitting module from the interval dimension of the T bars in parallel.

4. The device for supporting a light emitting module according to claim 2, comprising a biasing device biasing the light emitting module boarded in the recess portion of the supporting device on a side of the supporting device.

5. The device for supporting a light emitting module according to claim 2, wherein
the recess portion is formed in a rail shape possible to be inserted into a surface in a thickness direction of a long side portion of the supporting device by sliding from a side face of the peripheral end portion of the long side of the light emitting module.

6. The device for supporting a light emitting module according to claim 2, wherein
the supporting device has a reflective surface portion made of a flat or curved surface projecting on a front side from a light emitting surface of the light emitting module as getting closer to a remote side from the recess portion and reflects light outgoing from the light emitting module.

7. The device for supporting a light emitting module according to claim 6, wherein the supporting device has a cross sectional shape of an approximately V shape in a case of supporting the light emitting module in a plurality of rows in parallel and when arranged between the respective light emitting modules.

8. The device for supporting a light emitting module according to claim 2, wherein the supporting device has a cross sectional shape possible to be formed by extrusion molding in a direction along the recess portion.

9. The device for supporting a light emitting module according to claim 1, comprising a biasing device biasing the light emitting module boarded in the recess portion of the supporting device on a side of the supporting device.

10. The device for supporting a light emitting module according to claim 1, wherein
the supporting device has a reflective surface portion made of a flat or curved surface projecting on a front side from a light emitting surface of the light emitting module as getting closer to a remote side from the recess portion and reflects light outgoing from the light emitting module.

11. The device for supporting a light emitting module according to claim 10, wherein the supporting device has a cross sectional shape of an approximately V shape in a case of supporting the light emitting module in a plurality of rows in parallel and when arranged between the respective light emitting modules.

12. The device for supporting a light emitting module according to claim 1, wherein the supporting device has a cross sectional shape possible to be formed by extrusion molding in a direction along the recess portion.
